(19) United States
(12) Patent Application Publication
(10) Pub. No.: US 2026/0326842 A1
(43) Pub. Date: Oct. 22, 2026

(54) UTILITY VEHICLE HAVING A BATTERY CASE

(71) Applicant: Trailer Dynamics GMBH, Eschweiler (DE)

(72) Inventors: Abdullah JABER, Aachen (DE); Phillipp SUNDERMANN, Aachen (DE)

(73) Assignee: Trailer Dynamics GMBH, Eschweiler (DE)

(21) Appl. No.: 19/109,809

(22) PCT Filed: Sep. 4, 2023
(86) PCT No.: PCT/EP2023/074212

§ 371 Date: Mar. 7, 2025

(30) Foreign Application Priority Data
Sep. 12, 2022 (DE) 10 2022 123 162.3

(51) Int. Cl. B62D 59/04; B60K 1/04; B62D 21/02; H01M 50/242; H01M 50/249

(52) U.S. Cl. CPC B62D 59/04; B60K 1/04; B62D 21/02; H01M 50/242; H01M 50/249; B60K 2001/0438; B60K 2001/0444; H01M 2220/20

(57) ABSTRACT

The invention relates to a utility vehicle, in particular a trailer (20) for coupling to a semitrailer tractor, comprising a chassis (21), which is formed by crossmembers and longitudinal members for example and on the bottom side (22) of which at least one, in particular two or three, trailer axles (23) are arranged, wherein at least one trailer axle (23) is equipped with an electric drive unit (25) for driving and decelerating the utility vehicle (20), and comprising at least one battery case (10), which is arranged on the bottom side (22), for accommodating at least one electric battery module. According to the invention, provision is made for the battery case (10) to be connected to the chassis (21), wherein the battery case (10) is mounted on the chassis (21) in such a way that it is mechanically decoupled from the chassis (21) of the trailer (20).

The invention relates to a utility vehicle, in particular a trailer, having a battery case according to the preamble of claim 1.

Trailers (or semi-trailers) are used in road haulage or agriculture for transportation and work purposes, for example. For a long time, they were regarded as non-motorized utility vehicles and are usually mounted on a kingpin on a fifth wheel coupling of a diesel-engined tractor unit and carried along. Trailers have a chassis made up of crossmembers and longitudinal members and are usually multi-axle (usually 2 to 3 axles).

As electromobility continues to develop, concepts have emerged that equip the trailer with an additional drive unit to support the tractor unit. For example, one of the one, two or three trailer axles can be equipped with an electric motor/transmission unit. This opens up the possibility of supporting the tractor unit in drive and deceleration phases as required, thereby improving the overall energy efficiency of the utility vehicle.

Due to the nature of the system, large high-voltage battery modules are required for the energy supply of such a trailer. The HV battery modules must be safely stored on the trailer chassis.

In this context, problems arise in particular with regard to installation space.

Furthermore, the battery storage must meet increased safety requirements due to the high-voltage components. In addition, the demands placed on the structural integrity of the battery case are high. The battery modules housed in the battery case must be effectively protected against environmental influences such as moisture and dust. The protection of the electrical components and the electromagnetic shielding of the electrical components require a very rigid structure. However, the chassis of the trailer has much greater freedom than the battery case in terms of requirements. In particular, torsionally soft chassis pose a major challenge for the connection of the rigid battery case.

In the prior art, various design variants for battery cases and fastening constructions for holding and fixing a battery case to the underside of a trailer chassis are proposed.

Among these, for example, embodiments are proposed which provide a direct integrally bonded fixation of the battery case to the chassis of the trailer. Furthermore, embodiments can be identified, for example, which provide telescopic fastening elements directly on the chassis of the trailer in the vehicle vertical direction to hold the battery case, by means of which the battery case is fixed to the chassis of the trailer.

However, the solutions proposed in the prior art have various disadvantages, particularly for trailers with electric assist drives. For example, dynamic driving loads result in movements and/or torsion and/or vibrations on the trailer chassis, which are transferred directly to the battery case. Among other things, this leads to destabilization of the entire battery case structure. Furthermore, the solutions for battery cases proposed in the prior art are not sufficiently protected against environmental influences. Conversely, this also means that the environment of the battery case is equally affected by the high-voltage components of the HV battery modules, for example by electromagnetic fields.

Furthermore, the proposed solutions are not rigid enough and are often relatively heavy, wherein only a certain predefined battery dimension can be accommodated by the proposed battery cases. Due to the angular external structure and the relatively large external dimensions of the battery cases, the drag forces on the underside of the chassis also increase. In addition, the battery cases do not provide sufficient side collision or underride protection and can become severely deformed in the event of an impact. This in turn can lead to the battery case being torn off the chassis.

It is therefore the object of the present invention to overcome the disadvantages of the prior art and to provide an improved battery case for utility vehicles and in particular for powered trailers.

Main features of the invention are given in the characterizing part of claim 1. Embodiments are the subject of claims 2 to 20.

In a utility vehicle, in particular in a trailer for coupling to a tractor unit, comprising a chassis which is formed, for example, by crossmembers and longitudinal members and on the underside of which at least one, in particular two or three trailer axles are arranged, wherein at least one trailer axle is equipped with an electric drive unit for driving and decelerating the utility vehicle or trailer, and comprising at least one battery case arranged on the underside for accommodating at least one electric battery module, according to the invention, it is provided that the battery case is connected to the chassis, in particular to its longitudinal members, wherein the battery case is mounted on the chassis in such a way, wherein it is mechanically decoupled from the chassis of the trailer.

Due to the mounting of the battery case on the chassis according to the invention, the battery case is mechanically decoupled from the remaining elements of the utility vehicle. For example, so-called silent mounts can be arranged between the chassis and the battery case. The transfer of dynamic driving loads to the battery structure is thus prevented. This leads to a significant increase in mechanical strength and stability in the area of the battery case. At the same time, this measure improves the overall driving dynamics of the utility vehicle or the driven trailer.

According to a preferred embodiment of the invention, the trailer has support legs on the underside of the chassis for coupling and uncoupling, wherein the battery case is arranged in a space between the support legs and the trailer axle(s). The space is formed in particular between the foremost trailer axle and the support legs in the longitudinal and vehicle transverse direction. This intermediate space is particularly suitable for the arrangement of the battery case and for the connection to the electric drive due to space-saving aspects. The foremost trailer axle refers to the axle of the trailer that is closest to the support legs when viewed in the vehicle longitudinal direction. Preferably, the battery case extends in the vehicle longitudinal direction in such a way that substantially the entire space between the support legs and the front-most trailer axle in the longitudinal and vehicle transverse direction is filled by the battery case.

In this context, it is particularly preferable that the geometric dimensions of the battery case are adapted to the geometric dimensions of the chassis and, in particular, to the geometric dimensions of the outer edges of the chassis. As a result, all legal requirements and in particular the ECE R-73 regulation published by the European Economic Commission (ECE) with regard to the requirements to be met by a side impact guard are taken into account. Preferably, the side impact guard can be integrated into the battery case. This saves additional installation space and the sides of the battery case are additionally reinforced.

According to a preferred embodiment, the battery case has a cage structure for accommodating electrical battery modules, wherein the cage structure is modularized. Modularity in the sense of the invention means, among other things, the division of the entire cage structure into individual modules, which can be joined together or interact via corresponding interfaces if their form and function are suitable. This results in a modular system suitable for different battery dimensions. Conversely, this also means that individual modules of the cage structure can be replaced by alternative modules depending on the application. Modules that determine the basic framework or the outer frame of the cage structure can be retained so that, for example, the size of an interior space of the battery case in a vehicle's vertical direction can be adapted cost-effectively and with relatively little effort.

The modular cage structure preferably has an upper frame consisting of transverse and longitudinal elements, wherein the modular cage structure has a lower frame consisting of transverse and longitudinal elements arranged parallel to the upper frame. Further preferably, the upper and lower frames of the modular cage structure are detachably fixed together at corner areas by four corner traverses, wherein the corner traverses are arranged between the upper and lower frames and extending in the vehicle vertical direction. The corner traverses can preferably be replaced in a modular fashion depending on battery capacity and energy requirements, wherein the upper and lower frame can be used universally for every possible corner traverse. This means, for example, that shorter corner traverses can be used if fewer battery modules need to be accommodated.

Preferably, the modular cage structure has two longitudinal walls running in the vehicle longitudinal direction when the frames and corner traverses are fixed, wherein the modular cage structure has two transverse walls running in the vehicle transverse direction when fixed. The universally usable upper and lower frames, the interchangeable corner traverses and the longitudinal and transverse walls of the modular cage structure formed in the fixed state create a solid base frame and an interior area for accommodating the battery modules. At the same time, the corner traverses reinforce the frame structure of the battery case.

According to a further preferred embodiment, the invention provides that the modular cage structure has a front attachment structure for improving the aerodynamics of the trailer, wherein the front attachment structure is formed via an extension of the longitudinal walls. It is preferred that the front attachment structure and thus the extension on the longitudinal walls extends in the vehicle longitudinal direction up to the support feet. This counteracts increased air resistance forces and pressure gradients on the underside in the area of the flow-loaded transverse wall of the modular cage structure because less air flow and turbulence reaches the flow-loaded transverse wall of the battery case through the front attachment structure. The flows are thus advantageously guided along the front attachment structure and the longitudinal walls of the modular cage structure.

According to a further preferred embodiment, the front attachment structure of the modular cage structure is formed by an upper and a lower frame extension, which are detachably fixed to the longitudinal elements of the upper and lower frame, wherein the upper and lower frame extensions are fixed with shortened side wall elements. Preferably, the shortened side wall elements are arranged parallel to the corner traverses of the upper and lower frame extensions. Preferably, the shortened side wall elements are shorter in relation to the height of the corner traverses. This results in an inclined profile on the underside of the battery case, which further optimizes the aerodynamics and airflow. Due to the shorter design of the side wall element, the lower frame extension in particular not only extends in the vehicle longitudinal direction like the upper frame extension, but also in the vehicle vertical direction. Alternatively, further shapes and elements can be formed on the front attachment structure and/or on the relevant areas of the battery case to reduce air resistance. Together with the longitudinal walls, the front attachment structure formed by the upper and lower extensions also forms a safe side collision or underride guard that meets the legal requirements.

In a further preferred embodiment, the modular cage structure has a rear mounting structure for holding and connecting ancillary battery units. These may include power converters, voltage converters, control elements, battery management devices, etc. Preferably, the rear mounting structure is formed by an upper and a lower frame extension, which are detachably fixed to the longitudinal elements of the upper and lower frame, wherein the upper and lower frame extensions are detachably fixed to a rear mounting frame consisting of transverse and vertical elements. This advantageously creates a rear receiving area on the battery case, which can be used to hold and store the battery sub-assemblies and protect them as far as possible from undesirable influences. The rear mounting structure also reinforces and stiffens the modular cage structure. Due to the selected positioning, the auxiliary units are advantageously arranged between the electric drive unit and the electric battery modules. This considerably simplifies the connection of the corresponding connection lines. The rear attachment structure formed by the upper and lower frame extensions simultaneously forms a safe side collision or underride guard in the overall view with the longitudinal walls and with the front attachment structure, which meets the legal requirements and extends in particular in the vehicle longitudinal direction between the support legs of the trailer and the trailer axles.

In a further embodiment of the invention, it is provided that the longitudinal elements of the upper and lower frames are detachably fixed together by at least two, preferably at least three, side wall traverses arranged centrally in the region of the longitudinal walls, wherein the side wall traverses are arranged between the upper and lower frames and extending in the vehicle vertical direction. The side wall traverses reinforce the modular cage structure and also protect the battery modules arranged in the interior of the battery case in the area of the side collision protection. The central arrangement in the area of the longitudinal walls proves to be particularly advantageous in terms of mechanical strength, as the greatest bending stresses are to be expected in this area.

Preferably, all corner traverses and side wall traverses can each have two reinforcing elements arranged at the connection points to the upper and lower frames, wherein the reinforcing elements are particularly triangular in shape. It is further preferred that the triangular reinforcing elements rest with one leg against the corner traverses and side wall traverses, whereas another leg of the triangular reinforcing elements rests against the upper and lower frame of the cage structure. The reinforcing elements improve the introduction and transmission of forces in the area of the corner traverses and side wall traverses in particular. The dynamically occurring loads can thus be transferred via the upper frame of the modular cage structure to the respective traverses without generating mechanical stress peaks at the transition areas.

In order to be able to stow the connection lines in a compact and suitable manner without impairing the interior space for accommodating the battery modules, the modular cage structure preferably has at least two guide elements on each of its longitudinal walls for guiding and storing connection lines, wherein the guide elements are detachably fixed to the side wall traverses of the longitudinal walls and to the longitudinal elements of the upper frame. Preferably, the connection lines are arranged along the longitudinal and transverse walls and surround the battery modules arranged in the interior of the battery case. The connection lines are preferably hook-shaped and arranged around the battery modules in such a way that the shortest path is selected from the respective battery module along the transverse and longitudinal walls in the direction of the rear mounting structure. The connection lines can then be connected to the respective battery modules in the area of the rear mounting structure.

In order to reinforce the base of the battery case and to create a stable foundation for supporting the battery modules and for further stiffening the cage structure, the modular cage structure preferably has a middle longitudinal member that is arranged parallel to the longitudinal elements of the lower frame, wherein the middle longitudinal member rests on the transverse elements of the lower frame at the end face and is fixed in place. Further preferably, the middle longitudinal member is designed to match the shape of the transverse elements of the lower frame at the end face. This allows the middle longitudinal member to delimit or partially enclose the lower frame in the vertical and vehicle longitudinal direction and rest on the lower frame. When fixing the middle longitudinal member, this creates a tight fit via corresponding surface pressures. The middle longitudinal member divides the interior of the battery case into two equally sized areas for modular accommodation of the battery modules between the crossbars provided.

According to a preferred embodiment of the invention, at least one further side wall traverse is arranged centrally in the region of the transverse walls of the modular cage structure, wherein the side wall traverses are detachably fixed to the transverse and longitudinal elements of the upper and lower frame perpendicularly and in alignment with the middle longitudinal member in the vehicle transverse direction. The additional side wall traverses reinforce the transverse walls of the cage structure in particular. A single side wall traverse is sufficient because the cross walls are relatively short anyway and therefore have a higher rigidity. This saves material and manufacturing costs. At the same time, the overall weight of the cage structure is reduced as a result of the savings.

According to a further preferred embodiment of the invention, it is provided that the modular cage structure has at least two lateral longitudinal members which are arranged parallel and adjacent to the longitudinal elements of the upper frame, wherein the lateral longitudinal members rest on the transverse elements of the upper frame at the end face and are fixed. Further preferably, the lateral longitudinal members are designed to match the shape of the transverse elements of the upper frame on the end face. This allows the side longitudinal members to delimit the upper frame in the vertical and vehicle longitudinal direction and to rest partially on the upper frame. The side longitudinal members are advantageously suitable for fixing purposes on the underside of the chassis and carry the majority of the battery case or the modular cage structure. Due to the laterally offset arrangement of the side longitudinal members in relation to the middle longitudinal member, a mechanical balance is achieved and the modular cage structure is additionally reinforced in the area of the longitudinal walls. Preferably, the central and lateral side members of the modular cage structure can be more solid than the corner and side wall traverses.

Preferably, the modular cage structure provides at least eight, preferably at least sixteen crossbars for the modular accommodation and fixing of the electric battery modules, which extend in the vehicle transverse direction and are detachably fixed to the corner traverses and/or to the side wall traverses. Preferably, the crossbars are arranged at constant intervals in the vehicle vertical direction. This allows the battery modules to be fixed laterally to the crossbars and stacked on top of each other. Overall, the high number of crossbars, side wall traverses and corner traverses creates a very rigid cage structure that forms a mechanical framework. The battery modules positioned in the interior are effectively protected by the mechanical truss structure in the event of an impact.

It is particularly preferred that the crossbars extend in the vehicle transverse direction up to the middle longitudinal member, wherein the middle longitudinal member has at least two side wall traverses for fixing the crossbars. This preferred design means that the crossbars are shorter in the vehicle transverse direction, which additionally stiffens the entire modular cage structure. The two side wall traverses of the middle longitudinal member are preferably arranged opposite two side wall traverses of the longitudinal walls. As a result, the forces are distributed more evenly and the crossbars are guided straight and clean parallel to the transverse elements of the upper and lower frame.

According to a preferred embodiment of the invention, the middle longitudinal member and the lateral longitudinal members are identical to each other. Preferably, all four corner traverses of the modular cage structure are identical to each other. Further preferably, all side wall traverses of the modular cage structure are formed identically to each other. Above all, this supports simple production and simple assembly of the battery case. The fact that the respective modules or elements are identical to each other means that no special positioning or pre-adjustment is required during assembly. At the same time, production effort and production costs are saved. This also opens up the possibility of equipping the modular cage structure with additional traverses as required or deliberately omitting traverses.

Preferably, the modular cage structure is fixed to a side of the lower frame and the middle longitudinal member facing away from the underside of the chassis with a sheet metal plate, wherein the sheet metal plate has openings on its side facing the underside for fixing further cage structure elements. The sheet metal plate is preferably arranged perpendicular to the transverse and longitudinal walls of the modular cage structure and forms a base for the battery case. The openings are advantageously suitable for fixing purposes because the lowest crossbars for holding the battery modules can also be fixed to the sheet metal plate. The sheet metal plate also creates a secure foundation for the interior of the cage structure.

According to a further preferred embodiment, the modular cage structure has a cover side that is parallel to the sheet metal plate. In this context, it is particularly preferred that the cover side, the longitudinal and transverse walls and the front and rear attachment structure of the modular cage structure are covered with a sheet metal cladding. This measure provides all-round protection for the battery case or the modular cage structure. The sheet metal cladding forms a closed interior, which advantageously ensures optimum shielding of the battery case and protects the interior and the battery modules arranged therein from dirt, moisture, dust, heat, UV radiation, vibrations, etc., among other things. The sheet metal cladding also protects the battery modules from side impacts. Furthermore, the sheet metal cladding creates a so-called Faraday cage. A Faraday cage is a casing made of an electrical conductor that is closed on all sides (in this case sheet metal cladding) and acts as an electrical or electromagnetic shield. In the case of external static or quasi-static electric fields, the inner area remains free due to the induced field. In the case of time-varying processes such as electromagnetic waves, the shielding effect is based on the eddy currents that form in the conductive sheet metal cladding, which counteract the external electromagnetic field. This also significantly protects the environment of the battery case from electromagnetic radiation and other influences. Otherwise, the environment of the battery case would be exposed to strong electromagnetic radiation due to the high-voltage components in the interior. Furthermore, the sheet metal cladding also ensures that the legal requirements for side impact protection are met, particularly in the area of the longitudinal walls of the modular cage structure. Preferably, the sheet metal cladding can comprise at least one light metal material. It is also preferable for the modular cage structure and all of its individual modules to comprise at least one light metal material. In addition to the shielding effect, this optimizes the weight of the battery case.

In order to achieve optimum electromagnetic shielding and at the same time to optimally protect the interior of the battery case from external influences, according to one embodiment of the invention, it is preferred that the sheet metal cladding and the cage structure are additionally sealed at all cut and contact points. Preferably, the relevant points are sealed with a weather-resistant adhesive sealant, in particular with Sikaflex. This ensures that the structure remains securely sealed despite increased humidity and severe weather conditions. Alternatively, body sealing tape can also be used to seal the relevant areas.

According to a further important embodiment of the invention, it is provided that the modular cage structure is designed to be suspended from the longitudinal members of the chassis, wherein, in the suspended state of the cage structure, the distance between the lateral longitudinal members in the vehicle transverse direction is greater than the distance between the two longitudinal members of the chassis. This design is particularly suitable from a structural and mechanical point of view. Because the chassis of trailers have several crossmembers between their longitudinal members, the installation space is correspondingly limited. Due to the greater distance between the side longitudinal members, the battery case can be suspended and fixed to the chassis via the side longitudinal members.

For secure suspension and fixing of the modular cage structure or the battery case, preferably at least three, preferably at least four fixing elements are provided on each of the lateral longitudinal members on the longitudinal members of the chassis, wherein the fixing elements are distributed in the vehicle longitudinal direction and arranged at equal distances on the lateral longitudinal members. It is preferred that the fixing elements are arranged opposite each other on the side longitudinal members along the vehicle transverse direction on one axis. It is preferred that each of the fixing elements has at least four claws, wherein the claws at least partially grip around the side longitudinal members. The partially encompassing claws of the fixing elements create a particularly secure and firm fit of the fixing elements on the lateral longitudinal members. The fact that the individual fixing elements are fixed opposite each other and at equal intervals on the side longitudinal members creates a uniform mechanical suspension on the longitudinal members of the chassis.

In this context, it is further preferable that receiving profiles corresponding to the fixing elements are fixed to the longitudinal members of the chassis, wherein the receiving profiles are arranged parallel to the underside and extend from the longitudinal members of the chassis in the direction of the longitudinal walls. Preferably, corresponding mounting plates are fixed to the fixing elements, wherein the mounting plates are arranged parallel to the underside of the chassis and extend from the fixing elements in the direction of the longitudinal members of the chassis.

The fact that the receiving profiles and the mounting plates protrude towards each other results in secure mounting and suspension via the mounting plates of the fixing elements. When suspending the cage structure, the special arrangement allows the mounting plates to be placed and fixed onto silent blocks quickly and easily and with a positive fit. As a result, the weight load of the entire battery case is evenly absorbed by the fixing elements and the lateral longitudinal members and the transmission of vibrations and oscillations is minimized.

According to a preferred embodiment, the mounting plates have reinforcing struts on their upper sides, wherein the mounting plates are attached to the fixing elements via lateral grooves that run in the vehicle transverse direction. Preferably, the fixing elements have slot-shaped recesses corresponding to the lateral grooves of the mounting plate. This effectively simplifies the installation and adjustment of the mounting plates.

In order to ensure a simple and safe mechanical decoupling of the battery case from the chassis of the trailer, a preferred embodiment of the invention provides that silent blocks for the mechanical decoupling of the battery case are fixed in the receiving profiles, wherein the mounting plates are placed on the silent blocks in a form-fitting manner and are detachably fixed to them. Silent blocks are relatively inexpensive connection elements and are particularly suitable for the present mounting. They typically have an intermediate layer of rubber. This effectively dampens the movements and vibrations that occur between the battery case and the chassis of the trailer during driving dynamics. In contrast to a so-called silent bushing (also known as a rubber mount), silent blocks do not contain any pivot bearings and therefore do not allow any rotational movements between the connected parts. The silent blocks preferably have a base plate for insertion into the receiving profiles.

Preferably, the receiving profiles have a mounting plate and two side skirts, wherein the side skirts have slot-shaped recesses that are formed perpendicular to the longitudinal members of the chassis. The slot-shaped recesses can be used to positively insert and fix the receiving profiles onto a suitable section of the longitudinal members of the chassis in the vehicle transverse direction. This results in a firm fit of the receiving profiles on the side members. Preferably, the receiving profiles can be a welded construction. Further preferably, the base plates of the silent blocks rest on the mounting plates of the receiving profiles and are detachably fixed to them, wherein the base plates extend in particular in the vehicle vertical direction and are more solid than the mounting plates of the receiving profiles. The base plates of the silent blocks stabilize the mounting and provide a solid base for the suspension of the mounting plates and fixing elements. They increase the mechanical strength values in the area of the battery case suspension.

According to a further preferred embodiment, the electric battery modules are HV traction battery modules, wherein the HV traction battery modules can realize operating voltages of at least 600 V, preferably at least 800 V. Utility vehicles have a very high system weight, which is why powerful high-voltage traction battery modules must be used to ensure an adequate energy supply for the electric traction drive. At the same time, the current intensity can be reduced in phases when charging and/or discharging the battery modules due to the high voltage level. The avoidance of current peaks has a particularly positive effect on the stress factor of the battery modules, which means that the battery modules are protected as far as possible. Overall, this measure can have a positive effect on the service life of the battery modules, depending on the route profile and load of the trailer.

According to a preferred embodiment of the invention, it is provided that the HV traction battery modules are fixed to the crossbars in the vehicle vertical direction and are arranged stacked on top of one another, wherein each of the HV traction battery modules has an energy capacity of at least 30 kWh, preferably at least 33.33 kWh. In accordance with the limited installation space on the underside of the chassis and the current state of development of battery technology, this provides sufficient electrical energy for the trailer drive.

According to a further preferred embodiment, the modular cage structure can accommodate up to three levels stacked on top of each other in the vehicle vertical direction, each with up to six HV traction battery modules, by means of the crossbars.

Preferably, each of the HV traction battery modules can have an energy capacity of at least 33.33 kWh.

According to a preferred specific embodiment, the invention provides that the modular cage structure has three levels stacked on top of each other in the vehicle vertical direction, each with six HV traction battery modules per level. It is preferred that the total of eighteen HV traction battery modules have a total energy capacity of 600 kWh. Each individual HV traction battery module of the total of eighteen HV traction battery modules preferably has an energy capacity of 33.33 kWh. In this design variant, a total of four corner traverses, ten side wall traverses, namely six side wall traverses on the longitudinal walls and four side wall traverses at the height of the middle longitudinal member, and sixteen crossbars are provided. The crossbars preferably extend between the longitudinal walls and the middle longitudinal member. This configuration ensures that the available installation space is fully and optimally utilized. As a result, sufficient energy capacity is achieved for fully loaded trailers. In addition, this configuration achieves maximum rigidity values because the maximum number of traverses is installed.

According to a further preferred special embodiment, the modular cage structure has two levels stacked on top of each other in the vehicle vertical direction, each with five HV traction battery modules per level. It is preferred that the ten HV traction battery modules have a total energy capacity of 300 kWh. Each individual HV traction battery module of the total of ten HV traction battery modules preferably has an energy capacity of 30 kWh. This configuration reveals the advantageous modularity of the invention. According to this embodiment variant, the corner traverses and side wall traverses are preferably shorter in the vehicle vertical direction. This saves installation space and material costs. The upper and lower frame can preferably be used universally, i.e. the elements of the upper and lower frame of the modular cage structure are adopted for every possible battery case height and used regardless of the size of the traverses. As the body remains unchanged in the vehicle longitudinal direction, the central and side longitudinal members can also be used. This configuration is ideal for use with smaller utility vehicles or trailers, for example. The configuration could also be used for trailers that are regularly half-loaded.

Further features, details and advantages of the invention are apparent from the wording of the claims and from the following description of embodiments with reference to the drawings, in which:

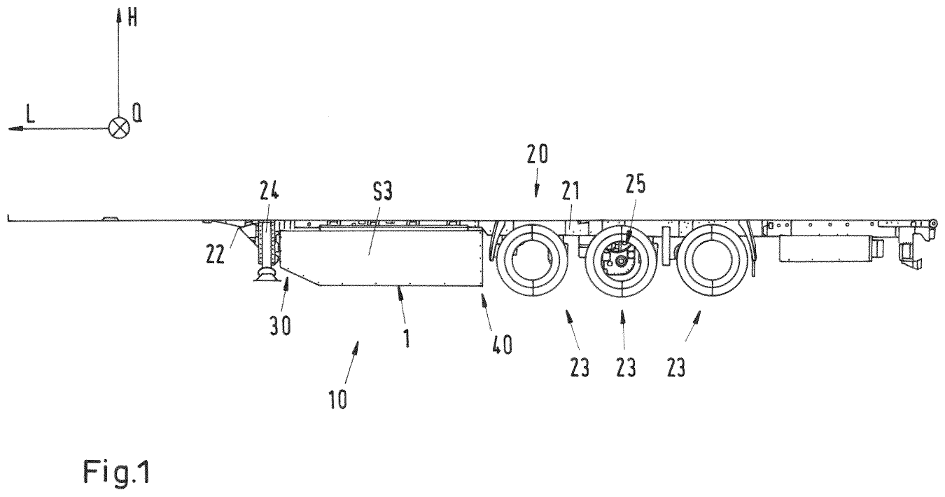

FIG. 1 is a schematic side view of a trailer according to the invention with a battery case;

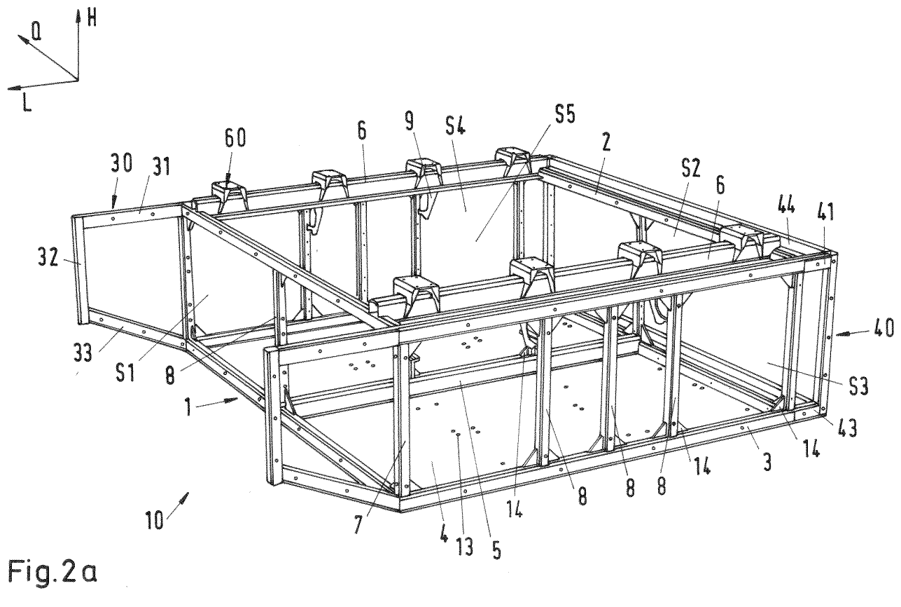

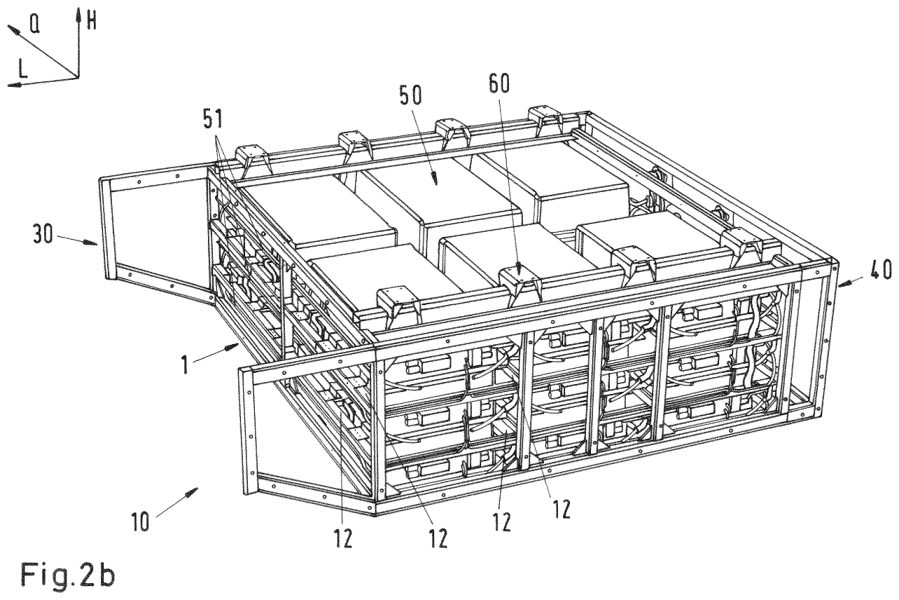

FIG. 2a is a schematic oblique view of a modular cage structure of the battery case of FIG. 1;

FIG. 2b is a schematic oblique view of the modular cage structure of FIG. 2a with integrated battery modules;

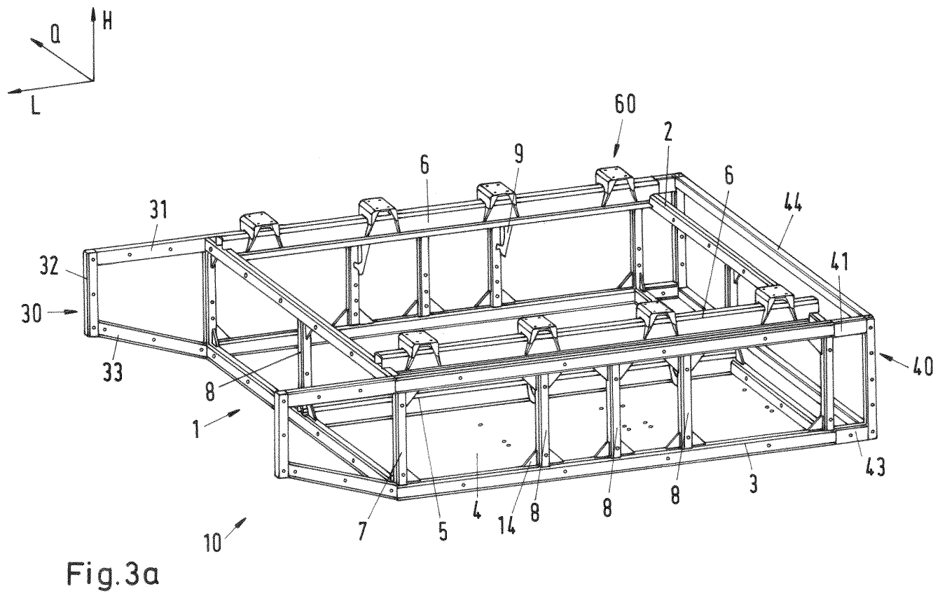

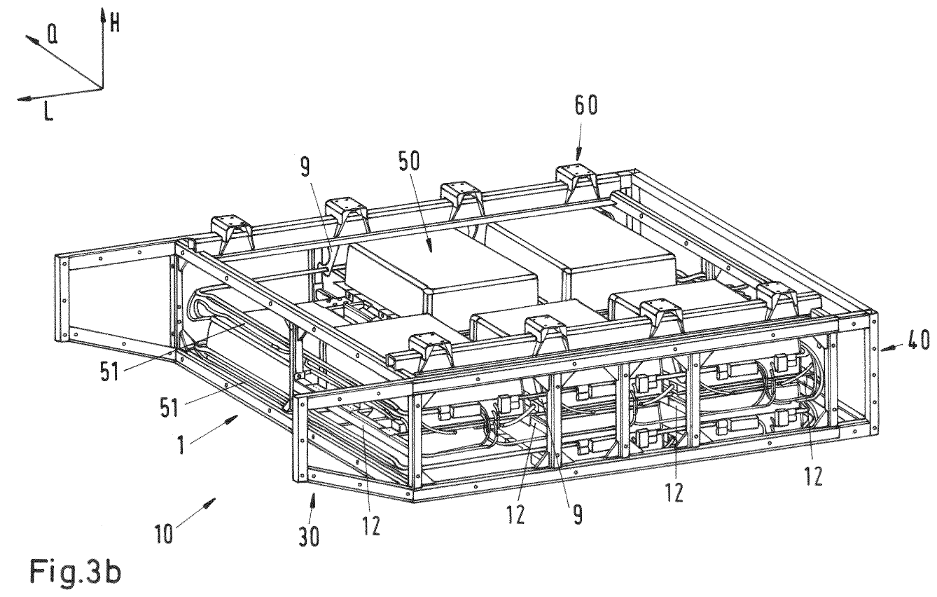

FIG. 3a is a schematic oblique view of an alternative embodiment of a modular cage structure;

FIG. 3b is a schematic oblique view of the cage structure of FIG. 3a with integrated battery modules;

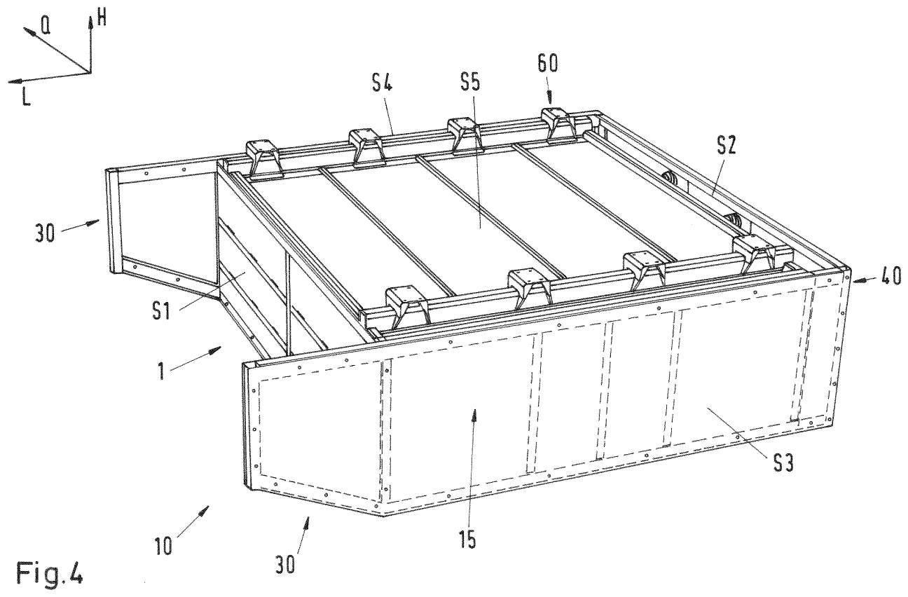

FIG. 4 is a schematic oblique view of the modular cage structure of FIG. 2b with sheet metal cladding fitted;

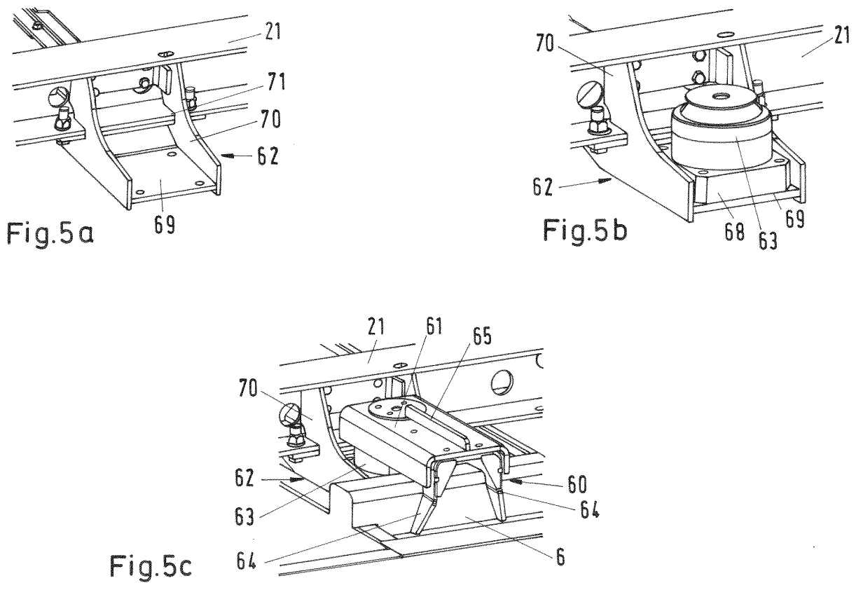

FIG. 5a is a schematic representation of a receiving profile for the suspension of the battery case;

FIG. 5b is a schematic representation of a silent block inserted into the receiving profile of FIG. 5a for the suspension of the battery case;

FIG. 5c is a schematic representation of a fixing element with a mounting plate for suspending the battery case.

FIG. 1 shows a trailer generally designated 20 and a battery case generally designated 10, which is positioned on a chassis 21 of the trailer 20.

The trailer 20 extends in a vehicle longitudinal direction L and comprises a chassis 21 formed by crossmembers and longitudinal members. The battery case 10 is mounted on the longitudinal members of the chassis 21 and is mechanically decoupled from the trailer 20 and the chassis 21. Three trailer axles 23 are arranged next to the battery case 10 on an underside 22 of the chassis 21. The middle one of the three trailer axles 23 is equipped with an electric drive unit 25 for driving and decelerating the trailer 20. In addition, the trailer 20 has support feet 24 on the side of the battery case 10 opposite the trailer axles 23 for coupling and uncoupling the trailer 20, wherein the battery case 10 is arranged in a space between the support feet 24 and the trailer axles 23. As can be seen, the battery case 10 is positioned between the foremost of the three trailer axles 23 and the support feet 24 and substantially fills this intermediate space completely.

The battery case 10 has a longitudinal wall S3, which merges into a front attachment structure 30 and a rear attachment structure 40. Furthermore, the battery case 10 comprises a modular cage structure 1 for accommodating electric battery modules.

By adding FIG. 2a and FIG. 2b, the details of the modular cage structure 1 and the exact arrangement of the electrical battery modules become apparent.

FIG. 2a shows the basic design of the cage structure 1 without battery modules inserted. The modular cage structure 1 has an upper frame 2 consisting of transverse and longitudinal elements, wherein the modular cage structure 1 has a lower frame 3 consisting of transverse and longitudinal elements arranged parallel to the upper frame 2. The upper and lower frames 2, 3 of the modular cage structure 1 are detachably fixed together at their corner areas by four corner traverses 7, wherein the corner traverses 7 are arranged between the upper and lower frames 2, 3 and extending in the vertical direction H of the vehicle.

In the fixed state, the modular cage structure 1 has two longitudinal walls S3, S4 extending in the longitudinal direction L of the vehicle and two transverse walls S1, S2 extending in the transverse direction Q of the vehicle. The dimensions of the transverse and longitudinal walls S1, S2, S3, S4 are selected such that the geometric dimensions of the battery case 10 are adapted to the geometric dimensions of the chassis 21 and, in particular, to the geometric dimensions of the outer edges of the chassis.

The modular cage structure 1 has a front attachment structure 30 for improving the aerodynamics of the trailer 20, formed by an extension of the longitudinal walls S3, S4. The front attachment structure 30 of the modular cage structure 1 is formed by an upper and a lower frame extension 31, 33, which are detachably fixed to the longitudinal elements of the upper and lower frame 2, 3. The upper and lower frame extensions 31, 33 are fixed with shortened side wall elements 32. As can be seen, the shortened side wall elements 32 are arranged parallel to the corner traverses 7 of the upper and lower frame extensions 31, 33. Due to the shorter design of the side wall element 32, the lower frame extensions 33 of the longitudinal walls S3, S4 also extend in the longitudinal and vehicle vertical direction L, H.

The modular cage structure 1 also has a rear attachment structure 40 for holding and connecting ancillary battery units. These can include power converters, voltage converters, control elements, battery management devices, etc. The rear mounting structure 40 is formed by an upper and a lower frame extension 41, 43, which are detachably fixed to the longitudinal elements of the upper and lower frame 2, 3. The rear attachment structure also has a rear attachment frame 44, which is arranged parallel to the transverse wall S2 and is detachably fixed to the upper and lower frame extensions 41, 43.

The longitudinal elements of the upper and lower frames 2, 3 are detachably fixed together by three side wall traverses 8 arranged centrally in the area of the longitudinal walls S3, S4. The side wall traverses 8 are arranged vertically between the upper and lower frames 2, 3 and extend in the vehicle vertical direction H. The side wall traverses 8 are arranged on the longitudinal walls S3, S4 opposite each other on one axis.

Two reinforcing elements 14 are provided on each of the corner traverses 7 and side wall traverses 8 at the connection points to the upper and lower frames 2, 3, wherein the reinforcing elements 14 are triangular in shape. One leg of each of the triangular reinforcing elements 14 rests against the corner traverses 7 and side wall traverses 8, whereas another leg of the triangular reinforcing elements 14 rests against the upper and lower frames 2, 3 of the modular cage structure 1.

To accommodate and guide the connection lines of the battery modules, the modular cage structure 1 preferably has at least two hook-shaped guide elements 9 on each of its longitudinal walls S3, S4, wherein the guide elements 9 are detachably fixed to the side wall traverses 8 of the longitudinal walls S3, S4 and to the longitudinal elements of the upper frame 2

Furthermore, the modular cage structure 1 has a middle longitudinal member 5, which is arranged parallel to the longitudinal elements of the lower frame 3 and divides the interior of the battery case into two equally sized areas. The middle longitudinal member 5 rests on the end faces of the transverse elements of the lower frame 3 and is detachably fixed to these. The shape of the middle longitudinal member 5 is adapted to the transverse elements of the lower frame 3. A further side wall traverse 8 is arranged centrally in the area of the transverse walls S1, S2 of the modular cage structure 1, wherein the side wall traverses 8 are detachably fixed to the transverse and longitudinal elements of the upper and lower frame 2, 3 perpendicularly and in alignment with the middle longitudinal member 5 in the transverse direction Q of the vehicle.

The modular cage structure 1 also has two lateral longitudinal members 6, which are arranged parallel and adjacent to the longitudinal elements of the upper frame 2, wherein the lateral longitudinal members 6 rest on the transverse elements of the upper frame 2 at the end face and are detachably fixed. The lateral longitudinal members 6 are adapted to the shape of the transverse elements of the upper frame 2 at the ends. As can be seen, the middle longitudinal member 5 and the lateral longitudinal members 6 of the modular cage structure 1 are more solid than the corner and side wall traverses 7, 8 and than the frame elements of the upper and lower frame 2, 3. The middle longitudinal member 5 and the lateral longitudinal members 6 are identical to each other.

The modular cage structure 1 also has a sheet metal plate 4 on a side of the lower frame 3 and the middle longitudinal member 5 facing away from the underside 22 of the chassis 21. The sheet metal plate 4 is provided with openings 13 for fixing further cage structure elements on its side facing the underside 22. The sheet metal plate 4 is arranged perpendicular to the transverse and longitudinal walls S1, S2, S3, S4 of the modular cage structure 1 and forms a base for the battery case 10. Parallel to and opposite the sheet metal plate 4, the modular cage structure 1 has a cover side S5.

Furthermore, the modular cage structure 1 is designed to be suspended from the longitudinal members of the chassis 21 and for this purpose has four fixing elements 60 on each of the lateral longitudinal members 6. The fixing elements 60 are distributed in the longitudinal direction L of the vehicle and are arranged at equal distances on the side longitudinal members 6. The fixing elements 60 are arranged opposite one another on the side longitudinal members 6 along the transverse direction Q of the vehicle on one axis.

By looking at FIG. 2a and FIG. 2b together, it can be seen that the modular cage structure for holding and fixing the electric battery modules has sixteen crossbars 12, which extend in the transverse direction Q of the vehicle and are detachably fixed to the corner traverses 7 and/or to the side wall traverses 8. The crossbars 12 are arranged at constant intervals in the interior of the cage structure 1 in the vertical direction H of the vehicle.

The battery modules are high-voltage traction battery modules 50 (HV traction battery modules for short). The HV traction battery modules 50 are detachably fixed laterally with their transverse sides to the crossbars 12 and are arranged stacked on top of one another. The crossbars 12 each extend up to the middle longitudinal member 5. For this reason, two further vertical side wall traverses 8 are arranged on the longitudinal member 5 in order to be able to fix the crossbars 12. The two further side wall traverses 8 of the middle longitudinal member 8 are arranged opposite two side wall traverses 8 of the longitudinal walls S3, S4. The two further side wall traverses 8 are not visible in FIG. 2b due to the HV traction battery modules 50.

They can be seen to some extent in FIG. 2a.

As can be seen in FIG. 2b, the modular cage structure 1 has three levels stacked on top of each other in the vehicle vertical direction H, each with six HV traction battery modules 50 per level. Each individual HV traction battery module 50 of the total of eighteen HV traction battery modules 50 has an energy capacity of 33.33 kWh in the exemplary embodiment shown. This results in a total energy capacity of 600 kWh. Furthermore, connection lines 51 are arranged along the longitudinal and transverse walls of the modular cage structure 1 and surround the HV traction battery modules 50 arranged in the interior of the battery case.

The modularity of the battery case 10 is illustrated in a combined view of FIG. 3a and FIG. 3b. The figures show a modular cage structure 1 that is shorter in the vehicle's vertical direction H. Apart from the side wall traverses 8 and the corner traverses 7, each individual modular element of the embodiment of FIG. 2a and FIG. 2b described above is modular and identical. Only the corner traverses 7 and the side wall traverses 8 are shorter in the vehicle's vertical direction H according to this exemplary embodiment.

As illustrated in particular in FIG. 3b, the modular cage structure 1 has two levels stacked on top of each other in the vehicle vertical direction H, each with five HV traction battery modules 50 per level. Each individual HV traction battery module 50 of the total of ten HV traction battery modules 50 has an energy capacity of 30 kWh in the exemplary embodiment shown. This results in a total energy capacity of 300 kWh. Furthermore, connection lines 51 are arranged along the longitudinal and transverse walls of the modular cage structure 1 and are routed through the guide elements 9. The connection lines 51 are routed through the guide elements 9 in such a way that they surround the HV traction battery modules 50 arranged in the interior of the cage structure 1.

FIG. 4 shows the embodiment shown in FIG. 2b with an additional sheet metal casing. The HV traction battery modules 50 are placed in the interior of the battery case 10 or the modular cage structure 1. As can be seen, the transverse walls S1, S2, the longitudinal walls S3, S4, the cover side S5, as well as the front and rear attachment structure 30, 40 of the modular cage structure 1, are all covered with a sheet metal cladding 15. All cut and contact points created by the cladding are additionally sealed with a weather-resistant adhesive sealant.

FIG. 5a to FIG. 5c illustrate the detailed designs of the fixing elements 60. Each fixing element 60 four claws 64, wherein the claws 64 are placed form-fittingly on the lateral longitudinal members 6 or at least partially embracing them. Support profiles 62 corresponding to the fixing elements 60 are fixed to the longitudinal members of the chassis 21, wherein the receiving profiles 62 are arranged parallel to the underside 22 and extend from the longitudinal members of the chassis 21 in the direction of the longitudinal walls S3, S4.

Mounting plates 61 corresponding to the receiving profiles 62 are fixed to the fixing elements 60, wherein the mounting plates 61 are arranged parallel to the underside 22 of the chassis 21 and extend from the fixing elements 60 in the direction of the longitudinal members of the chassis 21. The mounting plates 61 have reinforcing struts 65 on their upper sides, wherein the reinforcing struts 65 extend in the transverse direction Q of the vehicle.

Silent blocks 63 for the mechanical decoupling of the battery case 10 are fixed in the receiving profiles 62, wherein the mounting plates 61 are placed positively on the silent blocks 63 and are detachably fixed to them. The silent blocks 63 have a base plate 68, which rest on the mounting plates 69 of the receiving profiles 62 and are detachably fixed to these. The base plates 68 extend further than the mounting plates 69 in the vertical direction H of the vehicle and are more solid than the mounting plates 69 of the receiving profiles 68.

The receiving profiles 62 each have a mounting plate 69 and two side skirts 70, wherein the side skirts 70 have slot-shaped recesses 71, which are formed perpendicular to the longitudinal members of the chassis 21. The slot-shaped recesses 71 can be used to positively insert and fix the receiving profiles 62 onto a suitable section of the longitudinal members of the chassis 21 in the transverse direction Q of the vehicle.

The invention is not limited to one of the embodiments described above, but can be modified in a variety of ways

All features and advantages resulting from the claims, the description and the drawing, including design details, spatial arrangements and process steps, can be essential to the invention both individually and in various combinations.

List of reference signs

| L | vehicle longitudinal direction |
|---|---|
| Q | vehicle transverse direction |
| H | vehicle vertical direction |
| S1 | transverse wall |
| S2 | transverse wall |
| S3 | longitudinal wall |
| S4 | longitudinal wall |
| S5 | cover side |
| 1 | modular cage structure |
| 2 | upper frame |
| 3 | lower frame |
| 4 | sheet metal plate |
| 5 | middle longitudinal member |
| 6 | lateral longitudinal member |
| 7 | corner traverses |
| 8 | side wall traverses |
| 9 | guide elements |
| 10 | battery case |
| 12 | crossbars |
| 13 | sheet metal plate openings |
| 14 | reinforcing elements |
| 15 | sheet metal cladding |
| 20 | trailer |
| 21 | chassis |
| 22 | underside |
| 23 | trailer axles |
| 24 | support feet |
| 25 | electric drive unit |
| 30 | front attachment structure |
| 31 | upper frame extension |
| 32 | shortened side wall element |
| 33 | lower frame extension (angled) |
| 40 | rear mounting structure |
| 41 | upper frame extension |
| 43 | lower frame extension |
| 44 | rear mounting frame |
| 50 | HV traction battery module |
| 51 | battery connection lines |
| 60 | fixing elements |
| 61 | mounting plate |
| 62 | receiving profile |
| 63 | silent blocks |
| 64 | claw |
| 65 | stiffening strut |
| 68 | base plate silent blocks |
| 69 | receiving plate |
| 70 | side skirts |
| 71 | recess for side skirts |

1. A utility vehicle, in particular trailer (20) for coupling to a tractor unit, comprising
a chassis (21), on the underside (22) of which at least one, in particular two or three trailer axles (23) are arranged, wherein at least one trailer axle (23) is equipped with an electric drive unit (25) for driving and decelerating the utility vehicle (20), and
at least one battery case (10) arranged on the underside (22) for accommodating at least one electrical battery module,
characterized in that the battery case (10) is connected to the chassis (21), wherein the battery case (10) is mounted on the chassis (21) in such a way that it is mechanically decoupled from the chassis (21) of the trailer (20).

2. The utility vehicle as claimed in claim 1, characterized in that the trailer (20) has support feet (24) on the underside (22) of the chassis (21) for coupling and uncoupling, wherein the battery case (10) is arranged in an intermediate space between the support feet (24) and the trailer axle (23).

3. The utility vehicle as claimed in claim 1, characterized in that the battery case (10) has a cage structure (1) for accommodating electrical battery modules, wherein the cage structure (1) is of modularized design.

4. The utility vehicle as claimed in claim 3, characterized in that the modular cage structure (1) has an upper frame (2) made of transverse and longitudinal elements, wherein the modular cage structure (1) has a lower frame (3) made of transverse and longitudinal elements arranged parallel to the upper frame (2).

5. The utility vehicle as claimed in claim 4, characterized in that the upper and lower frames (2, 3) of the modular cage structure (1) are each detachably fixed to one another at their corner regions by four corner traverses (7), wherein the corner traverses (7) are arranged between the upper and lower frames (2, 3) and extend in a vehicle vertical direction (H).

6. The utility vehicle as claimed in claim 4, characterized in that the longitudinal elements of the upper and lower frame (2, 3) are detachably fixed together by at least two, preferably by at least three, side wall traverses (8) arranged centrally in the region of the longitudinal walls (S3, S4), wherein the side wall traverses (8) are arranged between the upper and lower frame (2, 3) and extend in the vertical direction (H) of the vehicle.

7. The utility vehicle as claimed in claim 6, characterized in that the modular cage structure (1) provides at least eight, preferably at least sixteen crossbars (12) for the modular accommodation of the electric battery modules, wherein the crossbars (12) extend in the vehicle transverse direction (Q) and are detachably fixed to the corner traverses (7) and/or to the side wall traverses (8).

8. The utility vehicle as claimed in claim 4, characterized in that the modular cage structure (1) has two longitudinal walls (S3, S4) extending in a vehicle longitudinal direction (L) in the fixed state of the frames and corner traverses, wherein the modular cage structure (1) has two transverse walls (S1, S2) extending in a vehicle transverse direction (Q) in the fixed state.

9. The utility vehicle as claimed in claim 4, characterized in that the modular cage structure (1) has a middle longitudinal member (5) which is arranged parallel to the longitudinal elements of the lower frame (3), wherein the middle longitudinal member (5) rests on the end faces of the transverse elements of the lower frame (3) and are detachably fixed.

10. The utility vehicle as claimed in claim 4, characterized in that at least one further side wall traverse (8) is arranged centrally in the region of the transverse walls (S1, S2) in each case, wherein the side wall traverses (8) are detachably fixed to the transverse elements of the upper and lower frame (2, 3) perpendicularly and in alignment with the middle longitudinal member (5) in the vehicle transverse direction (Q).

11. The utility vehicle as claimed in claim 4, characterized in that the modular cage structure (1) has at least two lateral longitudinal members (6) which are arranged parallel and adjacent to the longitudinal elements of the upper frame (2), wherein the lateral longitudinal members (6) rest on the end faces of the transverse elements of the upper frame (2) and are detachably fixed.

12. The utility vehicle as claimed in claim 8, characterized in that the modular cage structure (1) has a front attachment structure (30) for improving the aerodynamics of the trailer (20), wherein the front attachment structure (30) is formed via an extension of the longitudinal walls (S3, S4) in the vehicle longitudinal direction (L).

13. The utility vehicle as claimed in claim 8, characterized in that the modular cage structure (1) has a rear attachment structure (40) for accommodating and connecting battery side units, wherein the rear attachment structure (40) is formed via an extension of the longitudinal walls (S3, S4) in the vehicle longitudinal direction (L).

14. The utility vehicle as claimed in claim 4, characterized in that the modular cage structure (1) is fixed to a side of the lower frame (3) facing away from the underside (22) on the floor side by means of a sheet metal plate (4), wherein the sheet metal plate (4) has openings (13) on its side facing the underside (22) for fixing further cage structure elements.

15. The utility vehicle as claimed in claim 14, characterized in that the modular cage structure has a cover side (S5) lying parallel opposite the sheet metal plate (4), wherein the cover side (S5), the longitudinal and transverse walls (S1, S2, S3, S4) and the front and rear attachment structure (30, 40) of the modular cage structure (1) are clad with a sheet metal cladding (15).

16. The utility vehicle as claimed in claim 11, characterized in that the modular cage structure (1) is designed to be suspended from longitudinal members of the chassis (21), wherein, in the suspended state of the cage structure, the distance between the lateral longitudinal members (6) of the cage structure in the vehicle transverse direction (Q) is greater than the distance between the two longitudinal members of the chassis (21).

17. The utility vehicle as claimed in claim 11, characterized in that at least three, preferably at least four fixing elements (60) for suspending and fixing the cage structure (1) to the longitudinal members of the chassis (21) are provided on each of the lateral longitudinal members (6) of the cage structure, wherein the fixing elements (60) are distributed in the vehicle longitudinal direction (L) and, in particular, are arranged at equal distances on the lateral longitudinal members (6).

18. The utility vehicle as claimed in claim 17, characterized in that receiving profiles (62) corresponding to the fixing elements (60) are fixed to the longitudinal members of the chassis (21), wherein the receiving profiles (62) are arranged parallel to the underside (22) and extend from the longitudinal members of the chassis (21) in the direction of the longitudinal walls (S3, S4).

19. The utility vehicle as claimed in claim 18, characterized in that mounting plates (61) corresponding to the receiving profiles (62) are fixed on the fixing elements (60), wherein the mounting plates (61) are arranged parallel to the underside (22) of the chassis (21) and extend from the fixing elements (60) in the direction of the longitudinal members of the chassis (21).

20. The utility vehicle as claimed in claim 1, characterized in that silent blocks (63) for the mechanical decoupling of the battery case (10) are fixed in the receiving profiles (62), wherein the mounting plates (61) are placed onto the silent blocks (63) in a form-fitting manner and are detachably fixed thereto.
